(19) United States
(12) Patent Application Publication
(10) Pub. No.: US 2008/0065761 A1
(43) Pub. Date: Mar. 13, 2008

(54) METHOD AND SYSTEM FOR RESPONDING TO REJECTED MESSAGES

(76) Inventor: Jeffrey Kenneth Wilson, Austin, TX (US)

Correspondence Address: IBM CORP (YA);C/O YEE & ASSOCIATES PC, P.O. BOX 802333, DALLAS, TX, 75380, US

(21) Appl. No.: 11/530,632

(22) Filed: Sep. 11, 2006

(51) Int. Cl. G06F 15/16; G06F 15/173

(52) U.S. Cl. 709/224; 709/206

(57) ABSTRACT

A computer-implemented method, apparatus, and computer program product for managing rejected messages. Metadata is extracted from a message for storing information about the message in response to the message being rejected based on a problem on an email server. The metadata includes an identification of the problem on the email server and an email identification. A failure notification is sent to a sending party. The failure notification includes the metadata and indicates that a problem has occurred on an email server causing the message to be rejected. A correction notification is sent based on correction notification preferences in response to correction of the message problem. The correction notification includes the metadata and indicates that the problem on the email server has been corrected.

### BACKGROUND

1. Technical Field

The present invention relates generally to an improved data processing system. More particularly, the present invention relates to a computer-implemented method, apparatus, and computer program product for responding to rejected messages.

2. Description of the Related Art

Modern computing technology has resulted in immensely complicated and ever-changing environments. The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The set of protocols used on the Internet is called transmission control protocol/Internet protocol (TCP/IP).

The Internet has revolutionized communications and commerce, as well as being a source of both information and entertainment. For many users, email is a widely used format to communicate over the Internet. The existence and continued acceptance and use of the Web and the Internet have resulted in many new and useful applications becoming available to users of the Internet. One useful and popular application that most everyone with access to the Internet uses is electronic mail (email). Email is an electronic message sent over connections between data processing systems on a network. Email allows for a method of personal communication without requiring face-to-face contact. An email account allows a user to communicate a message to an intended email recipient. This type of communication is available even if the recipient has a different service provider than the sender. Email is typically based on a standard communication protocol that allows the communication of messages between individuals that may have different service providers. Email allows communication across the different communication protocols using only the recipient's email address.

Many email servers maintain user space quotas. These quotas limit the amount of storage that a user is allowed to take up for storing email. For most businesses with large storage capacities and for individual users who typically receive very small email, this is not usually much of an issue. However, for the growing number of small businesses who are becoming more and more expected to handle email as part of their everyday business, ensuring a constant “online” status while managing expenses can be a challenge. For example, most customers now expect everyone from their lawn service provider to bakery to have a website and/or email contact information.

These companies cannot afford in-house email servers or expensive large quotas or backup systems. Typically, these companies provide their customers with email addresses or personal Internet access accounts from free online services, such as Yahoo® or Hotmail®. Free email services provide base-level access but often set limits on memory space or other quotas.

The problem for an organization, such as a business, is that the employees do not have consistent or predictable email access. The employees are engaged in producing or delivering products or providing the service of the company, such as baking cakes, making deliveries, framing houses, landscaping yards, and the like. As a result, large emails may push a user past a designated quota, resulting in the email to the account being blocked for hours or even days. Similarly, the employee or owner may not notice that emails from customers or potential customers are being bounced back and not reaching the employee or owner. As a result, customers may be expecting an answer or feel they have wasted their time, and some of the customers and potential customers may take their business elsewhere. In other cases, the customer may be required to manually resend the email multiple times until the email delivery problem has been corrected on the email server. At the very least, un-received messages prevent customers from communicating with a business and portray the business in a negative light with respect to responsiveness.

### BRIEF SUMMARY

The illustrative embodiments described herein provide a computer-implemented method, apparatus, and computer program product for managing rejected messages. Metadata is extracted from a message for storing information about the message in response to the message being rejected based on a problem on an email server. The metadata includes an identification of the problem on the email server and an email identification. A failure notification is sent to a sending party. The failure notification includes the metadata and indicates that a problem has occurred on an email server causing the message to be rejected. A correction notification is sent based on correction notification preferences in response to correction of the message problem. The correction notification includes the metadata and indicates that the problem on the email server has been corrected.

### BRIEF DESCRIPTION OF THE DRAWINGS

The novel features believed characteristic of the illustrative embodiments are set forth in the appended claims. The illustrative embodiments, themselves, however, as well as a preferred mode of use, further objectives, and advantages thereof, will best be understood by reference to the following detailed description of an illustrative embodiment when read in conjunction with the accompanying drawings, wherein:

FIG. 1 is a pictorial representation of a data processing system in which illustrative embodiments of the present invention may be implemented;

FIG. 2 is a block diagram of a data processing system in which illustrative embodiments of the present invention may be implemented;

FIG. 3 is a block diagram depicting typical software architecture for a server-client system in which illustrative embodiments of the present invention may be implemented;

FIG. 4 is a block diagram of an email exchange system in accordance with an illustrative embodiment of the present invention;

FIG. 5 is a user interface for establishing correction notification preferences in accordance with an illustrative embodiment of the present invention;

FIG. 6 is a flowchart illustrating a process for sending correction notifications in accordance with an illustrative embodiment of the present invention; and

FIG. 7 is a flowchart illustrating a process for resending a message in accordance with an illustrative embodiment of the present invention.

### DETAILED DESCRIPTION OF AN ILLUSTRATIVE EMBODIMENT

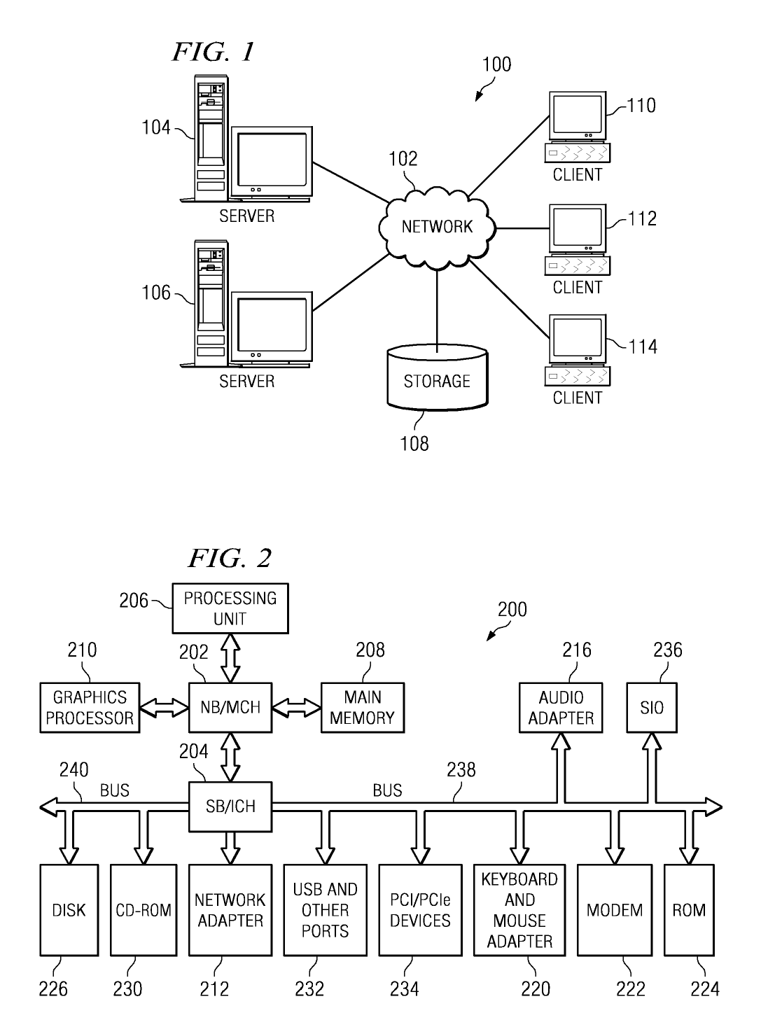

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which one or more embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 of FIG. 1, in which computer usable code or instructions implementing processes or methods as described herein may be located for illustrative embodiments of the present invention.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

In the illustrative embodiment of FIG. 2, an operating system runs on processor 206 and coordinates and provides control of various components within data processing system 200. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provide calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

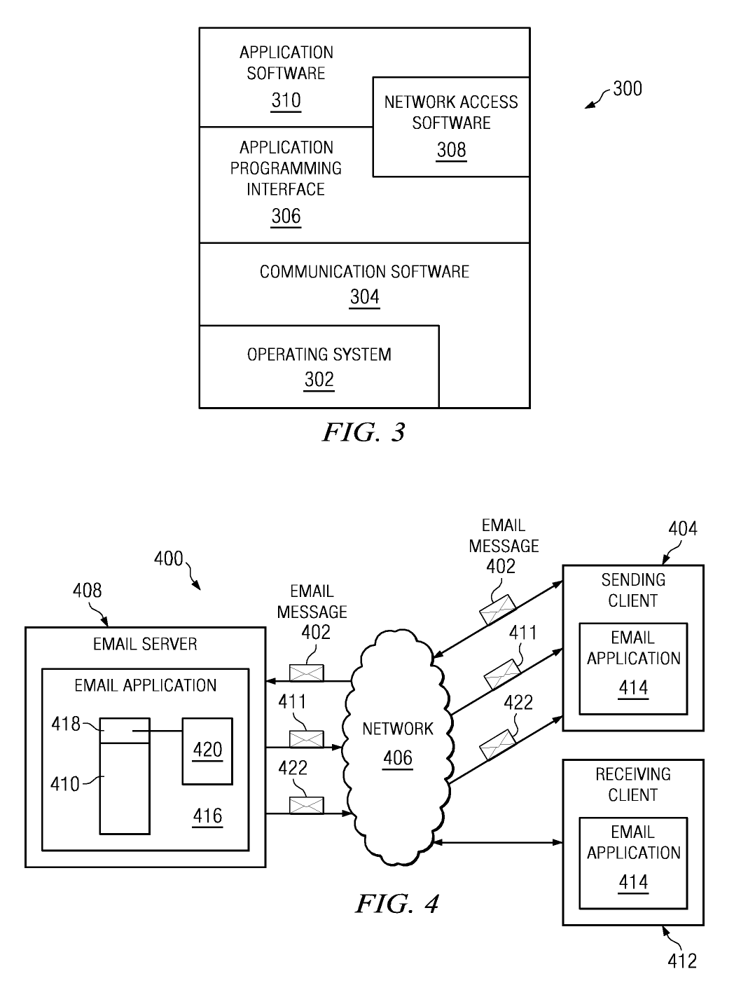

Turning to FIG. 3, typical software architecture for a server-client system is depicted in which illustrative embodiments of the present invention may be implemented. At the lowest level, operating system 302 is utilized to provide high-level functionality to the user and to other software. Such an operating system typically includes a basic input output system (BIOS). Communication software 304 provides communications through an external port to a network such as the Internet via a physical communications link by either directly invoking operating system functionality or indirectly bypassing the operating system to access the hardware for communications over the network.

Application programming interface (API) 306 allows the user of the system, an individual, or a software routine, to invoke system capabilities using a standard consistent interface without concern for how the particular functionality is implemented. Network access software 308 represents any software available for allowing the system to access a network. This access may be to a network, such as a local area network (LAN), wide area network (WAN), or the Internet. With the Internet, this software may include programs, such as Web browsers.

Application software 310 represents any number of software applications designed to react to data through the communications port to provide the desired functionality the user seeks, such as email messaging clients. Applications at this level may include those necessary to handle data, video, graphics, photos, or text which can be accessed by users of the Internet. The illustrative embodiments of the present invention may be implemented in any of the software elements of FIG. 3. In particular, the illustrative embodiments of the present invention may be implemented in application software 310, such as email application software, implemented on an email server such as server 104 of FIG. 1. The email application used by a user to access email on a server may be implemented using network access software 308 on a client such as client 110 of FIG. 1.

The illustrative embodiments of the present invention provide a computer implemented method, apparatus, and computer program product for responding to rejected messages. The illustrative embodiments of the present invention allow emails that are rejected back to the sender to be tracked by extracting important information. The important information is saved in storage space allocated for email messages that would not otherwise be received because the user has exceeded a quota. The extracted information may include minimal information for determining who sent the message and when, as well as the specified subject of the email message.

Email messages are most frequently rejected for surpassing a specified quota. The quota is a rule, term, parameter, or other limitation for the email server. The most frequent reason for email rejection results from the user exceeding a storage quota. Most email servers have quotas set in megabytes. Such storage quotas may be quickly surpassed when email messages include pictures, videos, or other memory intensive attachments, files, or objects. In another example, the user may have a quota specifying the maximum number of messages that may be received in a day. The quota may also specify that certain types of files, such as executable files, are unacceptable and therefore automatically rejected. Messages may also be rejected based on questionable or inappropriate content that may include viruses or other malicious programs. There may be any number of reasons why a message is rejected in addition to those examples provided herein.

The illustrative embodiments of the present invention allow the receiver to send a correction notification according to user preferences indicating that the email server problem has been corrected. The sender may automatically resend the original email message when the correction notification is received by associating the correction notification with the original email message.

FIG. 4 is a block diagram of an email exchange system in accordance with an illustrative embodiment of the present invention. Email exchange system 400 is an exemplary system for sending and receiving email messages. In one example, email message 402 is generated and sent from sending client 404 through network 406 to email server 408. Sending client 404 is used only for illustration purposes. Any number of sending clients may send messages in email exchange system 400. In this example, email message 402 is rejected from being received by email server 408 because the user has exceeded quota 410. As described, quota 410 is a storage quota but may take other forms. Subsequently, failure notification 411 may be returned to sending client 404. Failure notification 411 indicates that email message 402 was rejected by email server 408. As a result, the user or receiving party is unable to receive email message 402 at receiving client 412.

Sending client 404 and receiving client 412 may be clients, such as clients 110, 112, and 114 of FIG. 1. Email server 408 may be a server, such as servers 104 and 106 of FIG. 1. Sending client 404, receiving client 412, and email server 408 may communicate through network 406 using a land or hard line, such as fiber optics, telephone, cable, power lines, or may be received wirelessly.

Sending client 404 and receiving client 412 may use email application 414 to send and receive messages. Email application 414 may be a program application, such as Microsoft Outlook®, Eudora®, and other commonly used email applications. Alternatively, email application 414 may be an Internet browser or similar application for accessing email application 416 of email server 408. For example, a user accessing receiving client 412 may use Internet Explorer® to access email application 416, such as Yahoo® Mail on email server 408. Email applications 414 and 416 may be software applications, such as application software 310 of FIG. 3. Alternatively, email application 414 may be network access software, such as network access software 308 of FIG. 3.

In one illustrative embodiment, email server 408 allocates a portion of quota 410 as reserve 418. Reserve 418 is an allocated amount of storage or space, such as 100 kilobytes, used to store metadata about rejected messages. Metadata is limited data about email message 402 which may specify the sender, the subject, an email identifier, an error code, and the history of email message 402, such as when email message 402 was sent, rejected, and why. Reserve 418 may be specified by the user, email server administrator, or may simply be a default setting. In one embodiment, reserve 418 is an amount of storage above and beyond quota 410.

Failure notification 411 may include portions of the metadata. Particularly, the email identifier and error code are included in failure notification 411 for allowing email application 414 to identify email message 402 and why it was rejected. The email identifier may be a sequence of numbers or characters used to identify email message 402, such as 08240600015a. The email identifier may include information regarding the date and time email message 402 was originally received. The error code identifies the problem or reason email message 402 was rejected. For example, error code 201 may be used to indicate quota 410 has been exceeded.

Reserve 418 is used to store rejected message file 420. Rejected message file 420 is information or metadata extracted from a rejected message, such as name, email address, subject line, and date and time. Rejected message file 420 includes entries for each rejected message in concise terms so that each entry consumes very little space in reserve 418.

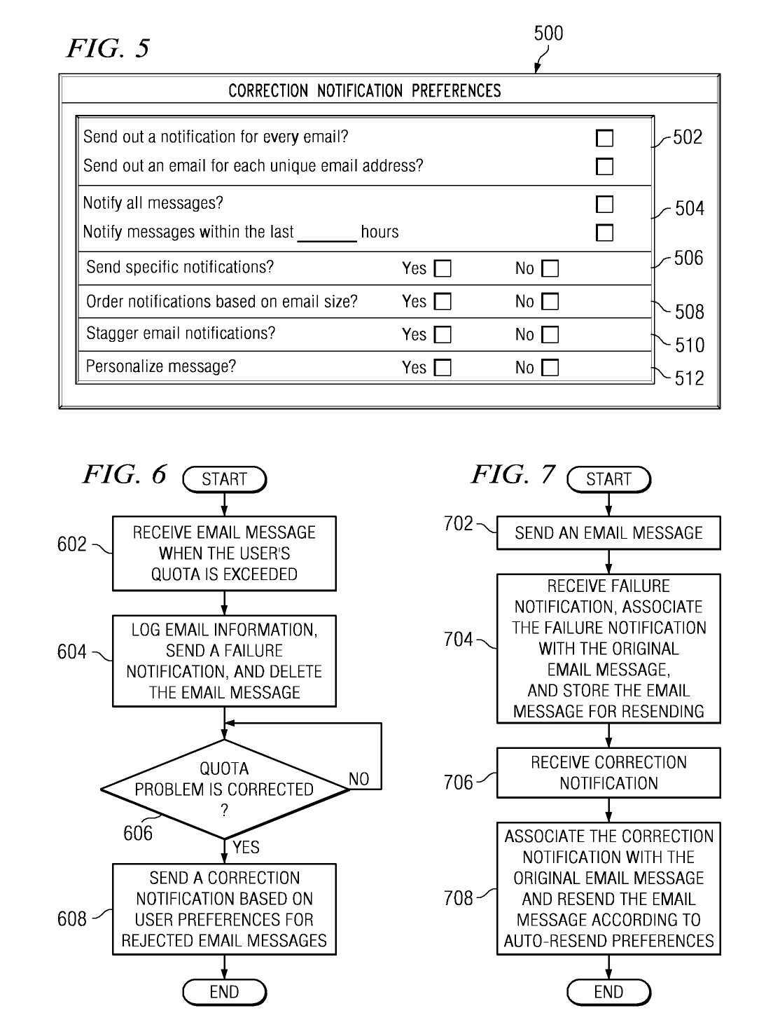

In one example, if the quota is 10 Mb, and 100 kb is specified for reserve 418, once the quota reaches 9.9 Mb, failure notification 411 is sent back to sending client 404. The receiving party may use receiving client 412 and email application 414 or email application 416 to establish correction notification preferences as further described in FIG. 5. The correction notification preferences are user preferences for sending correction notification 422. Correction notification 422 is a message indicating that messages have been deleted to make quota 410 compliant or that other email problems have been corrected by the receiving party, allowing email server 408 to receive additional email messages. Correction notification 422 indicates that email messages may now be received by email application 416 for access by receiving client 412. For example, once the receiving party has used receiving client 412 to delete messages so that the stored messages are acceptably within quota 410, correction notification 422 may be sent to sending parties that had email messages, such as email message 402, rejected.

Correction notification preferences may specify information regarding the number, type, time frame, order, stagger, personalized message, and other relevant preferences for sending one or more of correction notification 422 to at least one sending client 404. Correction notification 422 includes the email identifier and the error code for indicating that the problem that resulted in the failed delivery of email message 402 has been corrected so that email message 402 may be resent.

When failure notification 411 is sent as an email response to email message 402 indicating that quota 410 is surpassed, failure notification 411 is likely sent from a specific mailer daemon address with an email identifier and error code identifying the problem. When correction notification 422 is sent from email server 408 back to sending client 404 using the same mailer daemon address with the email identifier and error code. A mailer daemon is a program that runs continuously and exists for the purpose of handling periodic service requests, such as notifying sending parties that email messages have been rejected. The mailer daemon may be part of email application 416 used to send failure notification 411 and correction notification 422.

Email application 414 associates email message 402 with failure notification 411 when failure notification 411 is received using information, such as sending time, recipient, mailer daemon address, email address, or other identifiers. Email application 414 automatically stores email message 402 in a folder, such as drafts or “auto-resend”, in response to receiving failure notification 411. At any time, the user may click a button or give an indication, manually commanding email application 414 to resend, delete, or abandon resending email message 402.

Alternatively, the user may specify auto-resend preferences for specifying the circumstances and conditions for automatically resending email message 402. Email application 414 may be configured to associate correction notification 422 with failure notification 411 and email message 402. Email message 402, failure notification 411, and correction notification 422 may be associated using an email identifier, error code, mailer daemon address, or any other information. As a result, when correction notification 422 is received, email application 414 automatically resends email message 402. As a result, even though an original email message may have been rejected, email message 402 is resent for receipt by the receiving party once the problem has been taken care of.

FIG. 5 is a user interface for establishing correction notification preferences in accordance with an illustrative embodiment of the present invention. Correction notification preferences 500 may be displayed to a receiving party using receiving client 412 of FIG. 4. Correction notification preferences 500 is an example of a graphical user interface that allows a user to establish preferences for sending correction notifications, such as correction notification 422 of FIG. 4. Correction notification preferences 500 may be generated and stored by email applications 414 or 416 of FIG. 4.

Correction notification preferences 500 may include section 502. Section 502 allows a user to specify whether to send out a notification for each rejected email or alternatively to send out an email for each unique email address. For example, if a single sender has sent fifteen messages that were all rejected, section 502 allows the user to stipulate that only one correction notification be sent to the single sender or that one correction notification be sent for each rejected message. Section 502 prevents the email server from being overwhelmed when sending correction notifications.

Section 504 allows the user to specify to send the correction notification to all messages or messages received within a specified time period. For example, section 504 allows the user to specify that all messages rejected be responded to or that messages rejected in a specified time period, such as eight hours, be responded to. The user may use section 504 to specifically indicate which messages receive a correction notification based on a rejection time which may be entered in days, hours, and minutes. Section 504 may allow a user to prioritize which rejected messages are most important to respond to based on time of rejection.

Section 506 allows the user to send correction notifications to only specified addresses or exclude specified addresses. For example, if the user selects “yes” in section 506, the user may be prompted to enter individual addresses that are to receive a correction notification and individual addresses that are not to receive a correction notification. Section 506 allows a user to customize which addresses receive correction notifications or are excluded from receiving correction notifications for business or personal reasons.

Section 508 allows a user to send correction notifications based on email size. For example, if the user selects “yes”, the user may select to send messages from largest to smallest or from smallest to largest based on the overall size of each message that was rejected. Section 508 allows the user to address the problem of email size and which correction notifications should be sent first.

Section 510 allows the user to stagger sending correction notifications. For example, the user may select “yes” and use section 510 to specify that one message should be sent every five minutes in order to not overwhelm an email server, such as email server 408 of FIG. 4. Section 512 allows the user to specify a personalized message to be sent to all addresses sending a rejected message or to specified email addresses for business or personal reasons. For example, the user may select “yes” in section 510, select a specific email address, and then enter a message, such as “Jenn, please resubmit your order and I will process it as quickly as possible.”

In another illustrative embodiment of the present invention, correction notification preferences 500 may allow a user to specify that only a specified number of correction notifications are sent out based on the corresponding size of the original email message. This may ensure that the quota of the email server is not immediately overwhelmed by responses to the correction notifications.

FIG. 6 is a flowchart illustrating a process for sending correction notifications in accordance with an illustrative embodiment of the present invention. The process in FIG. 6 may be implemented by an email application in an email server, such as email application 416 of email server 408, both of FIG. 4. The process begins by receiving an email message when the user's quota is exceeded (process block 602). The message may be email message 402 of FIG. 4. For example, the message may be a 1 MB email where there is less than 1 MB of available space in the user's quota, such as quota 410 of FIG. 4. In process block 602, the email server determines that the message will be rejected based on software stipulations or other application rules in addition to quota specific rejections. For example, the user may not be allowed to send or receive executable files because of the threat of malicious programs. As a result, an executable file that is received is automatically rejected.

Next, the email application logs email information, sends a failure notification, and deletes the email message (process block 604). The important information may include an email identifier, error code, sender email, username, recipient, time stamp, subject, and other relevant information. The user may have established extraction preferences regarding the information extracted by the email application. The failure notification may be failure notification 411 of FIG. 4.

Next, the email application determines whether the quota problem is corrected (process block 606). The quota or other problem may be corrected by receiving client 412 using email applications 414 or 416. If the quota problem has not been corrected, the determination of process block 606 continues to loop. Once the quota problem is corrected in process block 606, the email applications sends a correction notification based on user preferences for rejected email messages (process block 608) with the process terminating thereafter. The correction notification may be correction notification 422 of FIG. 4. The correction notification may be set according to correction notification preferences 500 of FIG. 5.

FIG. 7 is a flowchart illustrating a process for resending a message in accordance with an illustrative embodiment of the present invention. The process in FIG. 7 may be implemented by an email application of a sending device, such as email application 414 or sending client 404 of FIG. 4.

The process begins by sending an email message (process block 702). The email message may be email message 402 of FIG. 4. Next, the email application receives a failure notification, associates the failure notification with the original email message, and stores the email message for resending (process block 704). The failure notification may be failure notification 411 received from email application 416 of email server 408, all of FIG. 4. The original message may be saved in a drafts folder, auto-resend folder, or other file or directory designated by the email application. Next, the email application receives a correction notification (process block 706). The correction notification may be correction notification 422 received from email server 408, both of FIG. 4. The correction notification is sent based on specified correction notification preferences 500 of FIG. 5.

Next, the email application associates the correction notification with the original email message and resends the email message according to auto-resend preferences (process block 708) with the process terminating thereafter. The correction notification may be associated with the original message using an identifier as described in FIG. 3.

Thus, the illustrative embodiments provide a computer implemented method, apparatus, and computer program product for responding to reject email message. Messages sent to a user and subsequently rejected are logged, cataloged, or otherwise recorded. Important information is extracted and saved in a file within a reserve so that the information may be accessed later. Because only portions of the message are extracted, large numbers of messages may be recorded using very little memory or storage. Once the user has corrected the quota problem, a correction notification is sent to the sending party according to correction notification preferences. The sending party may automatically associate the correction notification with the original message and resend the original message based on auto-resend user preferences. As a result, the sending and receiving parties are better able to respond to rejected email messages for more effective electronic communication.

Embodiments of the present invention may be implemented entirely in hardware, entirely in software or using a combination of both hardware and software elements. In one embodiment, the invention is implemented in software, including but not being limited to firmware, resident software, microcode, or the like.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a communication medium (e.g., a system bus). The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention embodiments in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for managing rejected messages, the computer implemented method comprising:
responsive to a message being rejected based on a problem on an email server, extracting metadata from the message for storing information about the message, wherein the metadata includes an identification of the problem on the email server and an email identification;
sending a failure notification to a sending party, wherein the failure notification includes the metadata and indicates that a problem has occurred on an email server causing the message to be rejected; and
responsive to correction of the message problem, sending a correction notification based on correction notification preferences, wherein the correction notification includes the metadata and indicates that the problem on the email server has been corrected.

2. The computer implemented method of claim 1, further comprising:
sending the message;
responsive to receiving the failure notification, associating the failure notification with the message and storing the message for resending; and
responsive to receiving the correction notification, associating the correction notification with the message and resending the message.

3. The computer implemented method of claim 2, wherein the associating is performed based on the metadata.

4. The computer implemented method of claim 2, further comprising:
resending the message according to auto-resend preferences.

5. The computer implemented method of claim 1, wherein the correction notification preferences allow a user to send a notification for each rejected message or to each unique email address, send the correction notification based on a specified time period, send failure notifications to specified email addresses, send the failure notifications based on message size, stagger sending the failure notifications, and personalize the message.

6. The computer implemented method of claim 3, wherein the metadata includes any of email identifier, error code indicating why the message was rejected, email address, mailer daemon address, subject, and time/date.

7. The computer implemented method of claim 1, wherein the message is an email and further comprises:
responsive to receiving an abort notification from a user, aborting attempts to resend the message and deletes the message; and
responsive to receiving a resend notification from a user, resending the message.

8. The computer implemented method of claim 2, wherein the identification of the problem is an error code.

9. The computer implemented method of claim 1, wherein the message is rejected because a message storage quota is exceeded.

10. The computer implemented method of claim 1, wherein the extracting further comprises:
extracting the metadata from the message based on user preferences; and
responsive to extracting the metadata from the message, discarding a remaining portion of the message.

11. A system comprising:
a sending client operably connected to an email server that sends a message to an email server for delivery to a receiving client, associates metadata from a failure notification with the message and stores the message for resending in response to receiving the failure notification, and resends the message in response to receiving a correction notification with the metadata;
the email server, wherein the email server runs an email application for sending and receiving email messages;
wherein the email application extracts the metadata from the message for storing information about the message in response to the message being rejected based on a problem on the email server, sends the failure notification to the sending client including the metadata, sends the correction notification including the metadata based on correction notification preferences, wherein the correction notification indicates the problem on the email server has been corrected.

12. The system of claim 11, wherein the receiving client accesses the email server, wherein the email application displays the metadata of rejected messages to the receiving client.

13. The system of claim 12, wherein the receiving client accesses the metadata using a browser.

14. The system of claim 12, wherein the receiving client accesses the metadata using a client email application stored on the receiving client.

15. The system of claim 12, wherein the problem indicates that a quota has been exceeded on the email server.

16. The system of claim 11, wherein the correction notification preferences allow a user to send a notification for each rejected message or to each unique email address, send the correction notification based on a specified time period, send failure notifications to specified email addresses, send the failure notifications based on message size, stagger sending the failure notifications, and personalize the message.

17. A computer program product comprising a computer usable medium including computer usable program code for managing rejected messages, the computer program product comprising:
computer usable program code responsive to a message being rejected based on a message problem, for extracting metadata from the message for storing information about the message;
computer usable program code for sending a failure notification to a sending party, wherein the failure notification includes the metadata and indicates that a problem has occurred on an email server causing the message to be rejected; and
computer usable program code responsive to correction of the message problem, for sending a correction notification based on correction notification preferences, wherein the correction notification includes the metadata and indicates that the problem on the email server has been corrected.

18. The computer program product of claim 17, further comprising:
computer usable program code for sending the message;
computer usable program code responsive to receiving the failure notification, for associating the failure notification with the message and storing the message for resending; and
computer usable program code responsive to receiving the correction notification, for resending the message.

19. The computer program product of claim 17, comprising computer usable program code for computer usable program code for receiving the message from a sending party;
computer usable program code for determining the message is a rejected message;
computer usable program code for extracting the metadata from the message based on user preferences;
computer usable program code responsive to extracting the metadata from the message for, discarding a remaining portion of the message.

20. The computer program product of claim 17, wherein the correction notification preferences allow a user to send a notification for each rejected message or to each unique email address, send the correction notification based on a specified time period, send failure notifications to specified email addresses, send the failure notifications based on message size, stagger sending the failure notifications, and personalize the message.
